(19) United States
(12) Patent Application Publication
(10) Pub. No.: US 2026/0093016 A1
(43) Pub. Date: Apr. 2, 2026

(54) LASER TRANSCEIVER CIRCUIT AND LASER DETECTION DEVICE

(71) Applicant: SUTENG INNOVATION TECHNOLOGY CO., LTD., Shenzhen (CN)

(72) Inventors: Keqin YANG, Shenzhen (CN); Changsheng GONG, Shenzhen (CN); Xiyan ZHANG, Shenzhen (CN)

(73) Assignee: SUTENG INNOVATION TECHNOLOGY CO., LTD., Shenzhen (CN)

(21) Appl. No.: 19/342,649

(22) Filed: Sep. 28, 2025

(30) Foreign Application Priority Data
Sep. 30, 2024 (CN) 202411390024.2

(51) Int. Cl. G01S 7/484; G01S 7/481

(52) U.S. Cl. CPC G01S 7/484; G01S 7/4813

(57) ABSTRACT

The application discloses a laser transceiver circuit and a laser detection device. The laser transceiver circuit includes a control module, a receiving module, and a transmitting module. The control module outputs a first pulse signal. The receiving module receives the first pulse signal, and outputs a second pulse signal based on the first pulse signal and determines a receiving starting moment of the receiving module based the second pulse signal; and the receiving module receives the echo signal reflected by the target object starting from the receiving starting moment. The control module receives the second pulse signal, and outputs N third pulse signals based on the second pulse signal; and N is an integer greater than or equal to 1. The transmitting module receives the N third pulse signals, and transmits laser to the target object based on the N third pulse signals.

### CROSS-REFERENCE TO RELATED APPLICATION

The present application claims the benefit of priority to Chinese Patent Application No. 202411390024.2, filed on Sep. 30, 2024, which is hereby incorporated by reference in its entirety.

### TECHNICAL FIELD

The embodiment of the application relates to the technical field of laser circuits, in particular to a laser transceiver circuit and a laser detection device.

### BACKGROUND

The laser detection device (such as a laser radar) is a system for detecting characteristic quantities such as the position and speed of a target object by emitting a laser beam, and its working principle is to emit detection laser (emitted by a transmitter) to the target object, and then compare the received echo signal (received by a receiver) reflected from the target with the emitted signal, and after appropriate processing, the detection information corresponding to the target object can be obtained, such as target distance, orientation, height, speed, and attitude information. In order to maintain the accuracy of the obtained detection information, the time difference between the moment when the transmitter emits the laser beam and the starting moment when the receiver receives the echo signal needs to be a fixed value, so that the moment when the transmitter emits the laser beam and the starting moment when the receiver receives the echo signal are synchronized.

The current operation mode is that the starting moment when the receiver receives the echo signal is determined by the working clock of the receiver, and the moment when the transmitter emits the laser beam is controlled by the controller, that is, the moment when the transmitter emits the laser beam is determined by the working clock of the controller. However, due to the existence of board card delay (such as wiring delay) and delay caused by internal devices (such as a phase-locked loop) of the receiver and the controller, the actual working clocks of the receiver and the controller are out of phase, thereby resulting in the emission moment of the laser beam by the transmitter and the starting moment of the echo signal by the receiver being unable to be synchronized, which ultimately leads to poor accuracy of the obtained detection information.

### SUMMARY

Embodiments of the application provide a laser transceiver circuit and a laser detection device, which can realize the synchronization between the moment when the transmitter emits the laser beam and the starting moment when the receiver receives reflection laser beam, and improve the accuracy of the obtained detection information.

In a first aspect, an embodiment of the present application provides a laser transceiver circuit, including a control module, a receiving module, and a transmitting module. The control module is used for outputting a first pulse signal; the receiving module is connected with the control module, and is used for receiving the first pulse signal, outputting a second pulse signal based on the first pulse signal, and determining a receiving starting moment of the receiving module based on the second pulse signal, where the receiving module starts to receive an echo signal reflected by a target object from the receiving starting moment; the control module is further used for receiving the second pulse signal, and outputting N third pulse signals based on the second pulse signal, where N is an integer greater than or equal to 1; and the transmitting module is connected with the control module, and is used for receiving the N third pulse signals, and emitting a laser to the target object based on the N third pulse signals.

In this way, the starting time of the receiving module and the time of the transmitting module transmitting the laser are both determined by the second pulse signal, so that the time difference between the starting time of the receiving module and the time of the transmitting module transmitting the laser is a fixed value, thereby synchronizing the starting time of the receiving module and the time of the transmitting module transmitting the laser, and facilitating improvement of the accuracy of the obtained detection information.

In one or more embodiments, the receiving module is further configured to determine the starting time of the receiving module based on a time point at which a first preset time period elapses from the starting time point of the second pulse signal.

In one or more embodiments, the control module is further configured to delay for an M-th time period in the N time periods from the starting time point of the second pulse signal, and output an M-th third pulse signal in the N third pulse signals at a time point at which the M-th time period ends, where one time period in the N time periods corresponds to one third pulse signal in the N third pulse signals, and M is an integer greater than or equal to 1 and less than or equal to N.

In one or more embodiments, the control module is further configured to obtain the M-th third pulse signal based on the second pulse signal, where a pulse width of the M-th third pulse signal is less than a pulse width of the second pulse signal.

By configuring the pulse width of the M-th third pulse signal to be a smaller value, the time resolution of the laser transceiver circuit can be significantly improved, the precision of the obtained detection information can be improved, and the energy emitted each time the laser is transmitted can be reduced, thereby reducing energy consumption.

In one or more embodiments, the control module includes a first delay unit, a first inverse unit, and a first AND unit. An input end of the first delay unit and a first input end of the first AND unit are both input with the second pulse signal, an output end of the first delay unit is connected with an input end of the first inverse unit, an output end of the first inverse unit is connected with a second input end of the first AND unit, and an output end of the first AND unit outputs the M-th third pulse signal.

In one or more embodiments, the control module includes a second delay unit, a second inverse unit, and a second AND unit. An input end of the second delay unit and an input end of the second inverse unit are both input with the second pulse signal, an output end of the second inverse unit is connected with a first input end of the second AND unit, an output end of the second delay unit is connected with a second input end of the second AND unit, and an output end of the second AND unit outputs the M-th third pulse signal.

In one or more embodiments, the control module includes a third delay unit, a fourth delay unit, a third inverse unit, and a third AND unit. An input end of the third delay unit is input with the second pulse signal, an output end of the third delay unit is connected with a first input end of the third AND unit and an input end of the fourth delay unit respectively, an output end of the fourth delay unit is connected with an input end of the third inverse unit, an output end of the third inverse unit is connected with a second input end of the third AND unit, and an output end of the third AND unit outputs the M-th third pulse signal.

In one or more embodiments, the control module includes a fifth delay unit, a sixth delay unit, a fourth inverse unit, and a fourth AND unit. An input end of the fifth delay unit inputs the second pulse signal, output ends of the fifth delay unit are connected with an input end of the fourth inverse unit and an input end of the sixth delay unit respectively, an output end of the fourth inverse unit is connected with a first input end of the fourth AND unit, an output end of the sixth delay unit is connected with a second input end of the fourth AND unit, and an output end of the fourth AND unit outputs the M-th third pulse signal.

In one or more embodiments, the transmitting module is further configured to output N feedback signals to the control module in response to the N third pulse signals, where each time the laser is transmitted in response to a K-th third pulse signal in the N third pulse signals, a K-th feedback signal in the N feedback signals is output to the control module based on a moment at which the laser is transmitted, K being an integer greater than or equal to 1 and less than or equal to N; and the control module is further configured to determine the moment at which the laser is transmitted by the transmitting module based on the K-th feedback signal, and adjust the detection information based on a difference between the moment at which the laser is transmitted by the transmitting module and a start moment of the K-th third pulse signal, where the detection information is information corresponding to the target object determined by the control module based on the echo signal.

In a second aspect, an embodiment of the application provides a laser detection device, including a housing and the laser transceiver circuit.

The laser transceiver circuit includes a control module, a receiving module, and a transmitting module. The control module outputs a first pulse signal to the receiving module. The receiving module outputs a second pulse signal based on the first pulse signal, and determines a receiving start moment of the receiving module based on the second pulse signal. The control module receives the second pulse signal, and outputs N third pulse signals to the transmitting module based on the second pulse signal. The transmitting module transmits a laser to a target object based on the N third pulse signals. The receiving start moment of the receiving module and the moment at which the laser is transmitted by the transmitting module are both determined by the second pulse signal, so that the time difference between the receiving start moment of the receiving module and the moment at which the laser is transmitted by the transmitting module is a fixed value, thereby synchronizing the receiving start moment of the receiving module and the moment at which the laser is transmitted by the transmitting module, and facilitating improvement of the accuracy of obtained detection information.

### BRIEF DESCRIPTION OF DRA WINGS

The embodiments are illustrated by way of example in the drawings, which are schematic and not intended to be drawn to scale. In the drawings, elements of the same reference sign indicate like elements.

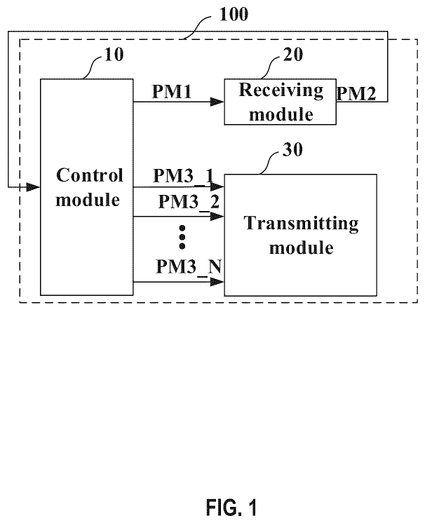

FIG. 1 is a schematic diagram of a composition block diagram of a laser transceiver circuit according to an embodiment of the present application;

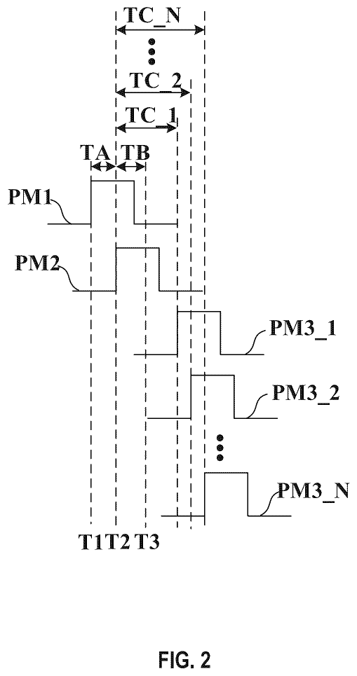

FIG. 2 is a schematic diagram of signals in the laser transceiver circuit shown in FIG. 1;

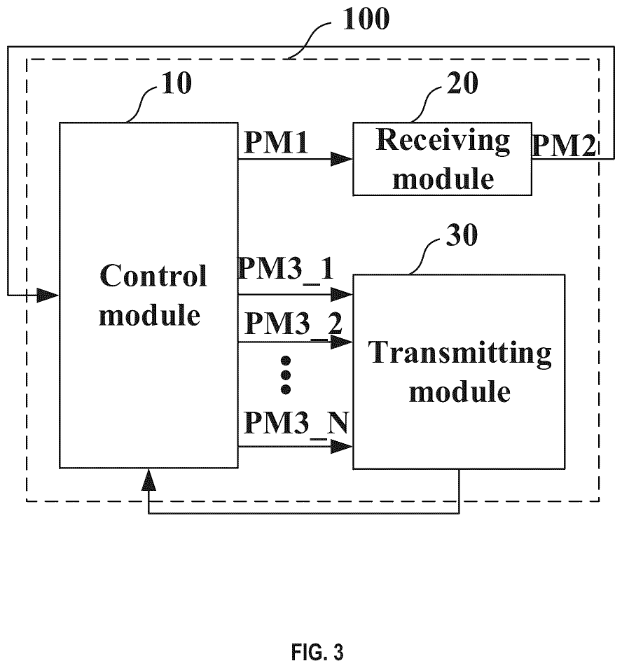

FIG. 3 is a schematic diagram of a composition block diagram of a laser transceiver circuit according to an embodiment of the present application;

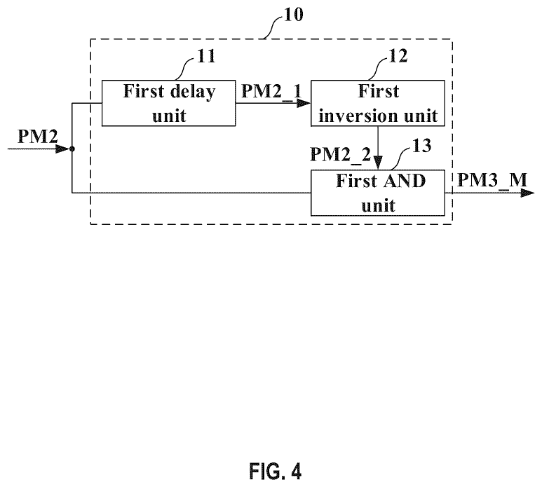

FIG. 4 is a schematic diagram of a composition block diagram of a control module according to an embodiment of the present application;

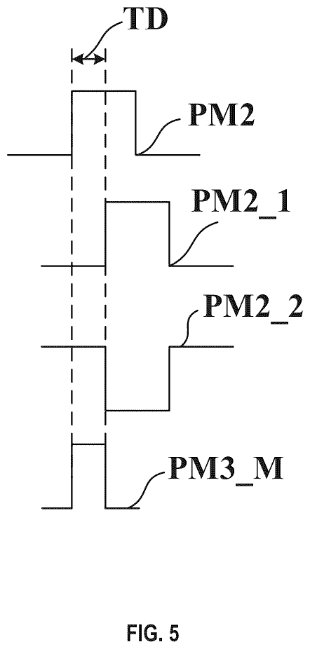

FIG. 5 is a schematic diagram of signals in the control module shown in FIG. 4;

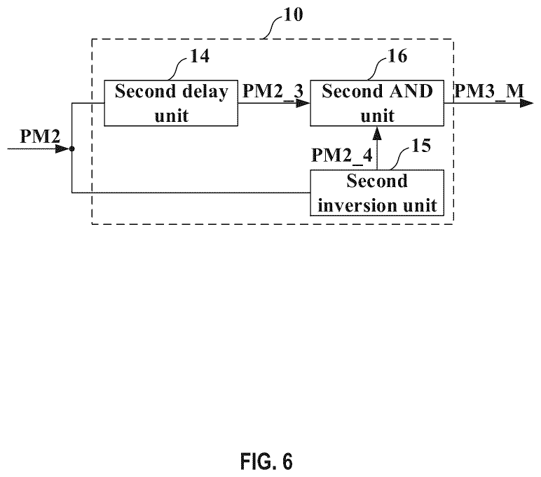

FIG. 6 is a schematic diagram of a second constituent block diagram of the control module according to an embodiment of the present application;

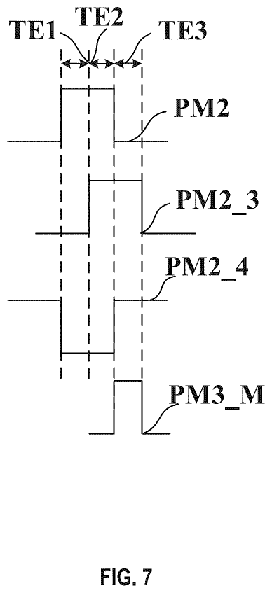

FIG. 7 is a schematic diagram of signals in the control module shown in FIG. 6;

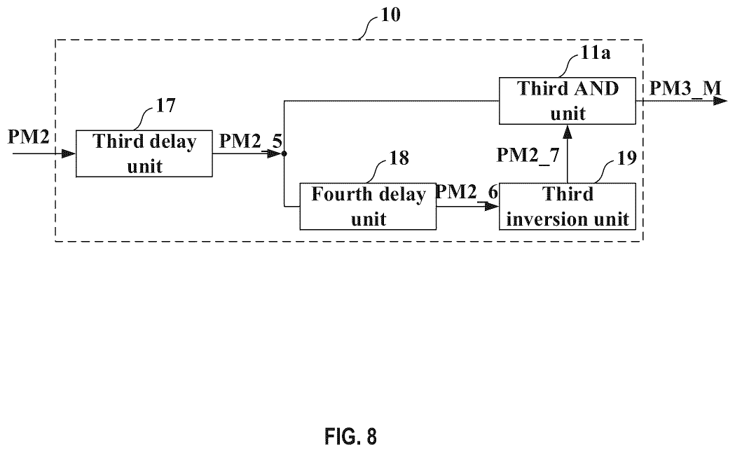

FIG. 8 is a schematic diagram of a third constituent block diagram of the control module according to an embodiment of the present application;

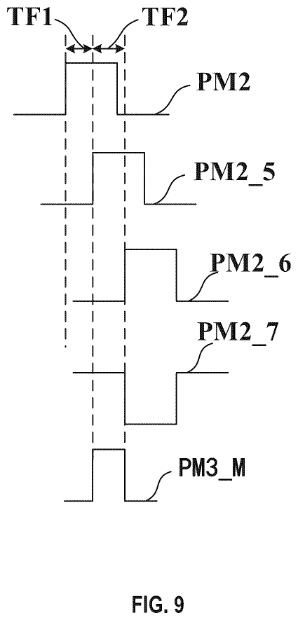

FIG. 9 is a schematic diagram of signals in the control module shown in FIG. 8;

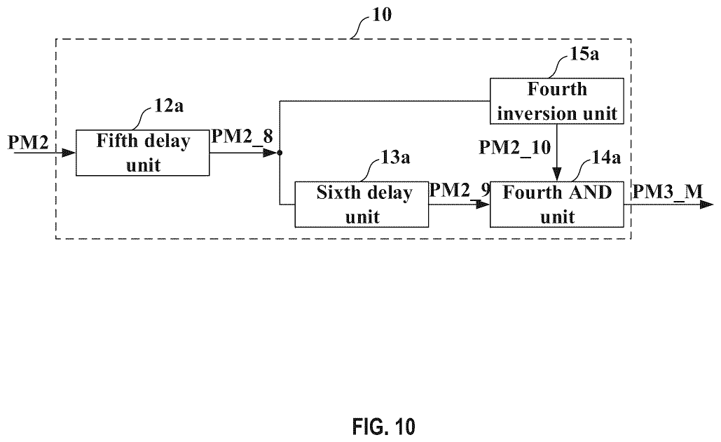

FIG. 10 is a schematic diagram of a fourth constituent block diagram of the control module according to an embodiment of the present application; and

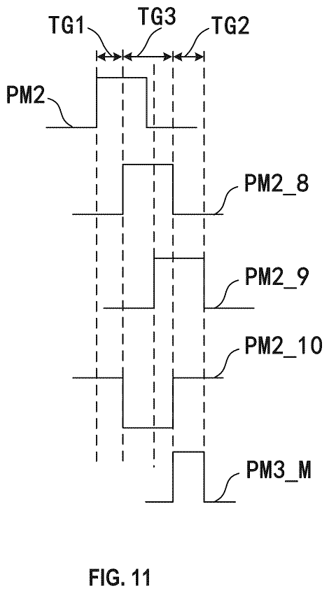

FIG. 11 is a schematic diagram of signals in the control module shown in FIG. 10.

### DETAILED DESCRIPTION

In the following, the technical solutions in the embodiments of the present application will be described in combination with the drawings. It is apparent that the described embodiments are only part of the embodiments of the present application, rather than all the embodiments. It should be understood that the specific embodiments described herein are used to explain the present application, rather than to limit the present application.

It should be noted that when an element is referred to as being “connected to” another element, it can be directly connected to the other element or may have one or more intervening elements disposed in between.

In addition, the technical features described in the various embodiments of the present application below can be combined with each other as long as they do not conflict with each other.

Referring to FIG. 1, which is a schematic diagram of a constituent block diagram of a laser transceiver circuit 100 according to an embodiment of the application. As shown in FIG. 1, the laser transceiver circuit 100 includes a control module 10, a receiving module 20, and a transmitting module 30. The control module 10 is connected to the receiving module 20 and the transmitting module 30 respectively.

The control module 10 is configured to output a first pulse signal PM1 to the receiving module 20. It should be understood that in the embodiments of the present application, each pulse signal (such as the first pulse signal PM1) can be in the form of voltage or current, and is characterized by rapidly jumping from one level to another and then returning to the original state after a period of time. In some embodiments, each pulse signal is a rectangular wave pulse signal.

In some embodiments, the control module 10 can be implemented by using a Field-Programmable Gate Array (FPGA) or a Microcontroller Unit (MCU), etc.

The receiving module 20 is configured to receive the first pulse signal PM1. Then, the receiving module 20 outputs a second pulse signal PM2 based on the first pulse signal PM1. For example, the receiving module 20 takes a moment, at which a second preset time duration elapses from a start moment of the first pulse signal PM1, as a start moment of the second pulse signal PM2, so as to output the second pulse signal PM2. After that, the receiving module 20 determines a receiving start moment of the receiving module 20 based on the second pulse signal PM2, where the receiving module 20 starts to receive an echo signal reflected by the target object from the receiving start moment. In some embodiments, the receiving module 20 determines the receiving start moment of the receiving module 20 based on a moment, at which a first preset time duration elapses from the start moment of the second pulse signal PM2.

Referring to FIG. 2, which exemplarily shows a schematic diagram of signals in the laser transceiver circuit 100 shown in FIG. 1. As shown in FIG. 2, a moment at which a second preset time duration (i.e., time duration TA) elapses from a start moment (i.e., moment T1) of the first pulse signal PM1 (i.e., moment T2), is taken as a start moment of the second pulse signal PM2. In this embodiment, the pulse width of the second pulse signal PM2 is taken to be the same as the pulse width of the first pulse signal PM1 as an example. In other embodiments, the pulse width of the second pulse signal PM2 can be set as different from the pulse width of the first pulse signal PM1, where the time duration TA≥0, and the time duration TA can be set based on an actual application scenario. Embodiments of the present application do not impose any specific limitation. Subsequently, a moment at which a first preset time duration (i.e., time duration TB) elapses from the start moment (i.e., moment T2) of the second pulse signal PM2 (i.e., moment T3) is used to determine the receiving start moment of the receiving module 20, that is, the receiving module 20 starts to receive the echo signal reflected by the target object from the moment T3.

Therefore, the receiving start moment of the receiving module 20 is determined by the second pulse signal PM2. For example, the receiving start moment of the receiving module 20 is determined by a moment at which the time duration TB elapses from the start moment of the second pulse signal PM2.

It can be understood that, in the embodiments of the present application, the start moment of each pulse signal refers to a moment at which the pulse of the signal first occurs. For example, the start moment of the second pulse signal PM2 is moment T2, at which the second pulse signal PM2 first appears. Correspondingly, the end moment of each pulse signal refers to a moment at which the pulse of the pulse signal ends.

In some embodiments, the receiving module 20 includes at least one receiving unit, and the receiving start moments of the receiving units are the same. The receiving module 20 includes a SPAD (Single-Photon Avalanche Diode) surface array. The SPAD surface array includes at least one SPAD unit, and the at least one SPAD unit is integrated on a plane to form a two-dimensional array, that is, the SPAD surface array, and each SPAD unit is a receiving unit.

Referring back to FIG. 1, the control module 10 receives the second pulse signal PM2 and outputs N third pulse signals based on the second pulse signal PM2, where N is an integer greater than or equal to 1. The N third pulse signals include a first third pulse signal PM3_1, a second third pulse signal PM3_2, and an N-th third pulse signal PM3_N. The pulse widths of different third pulse signals in the first third pulse signal PM3_1, the second third pulse signal PM3_2, and the N-th third pulse signal PM3_N can be the same or different.

The transmitting module 30 receives the N third pulse signals and emits laser light to the target object based on the N third pulse signals. In some embodiments, the transmitting module 30 includes at least one emission unit, and each emission unit can emit laser light once based on one third pulse signal, or each emission unit can continuously emit laser light multiple times based on multiple third pulse signals. For example, in some embodiments, the transmitting module 30 includes N emission units, and each emission unit emits laser light once based on one third pulse signal. In some embodiments, the transmitting module 30 includes one emission unit, and the emission unit emits laser light for the first time based on the first third pulse signal PM3_1, emits laser light for the second time based on the second third pulse signal PM3_2, and emits laser light for the N-th time based on the N-th third pulse signal PM3_N, so that the emission unit can continuously emit laser light for N times.

In some embodiments, the transmitting module 30 includes a VCSEL (Vertical-Cavity Surface-Emitting Laser) surface array. The VCSEL surface array includes at least one VCSEL unit, and the at least one VCSEL unit is integrated on a plane to form a two-dimensional array, i.e., the VCSEL surface array, where each VCSEL unit is an emission unit.

In some embodiments, the control module 10 is further configured to delay for an M-th time duration in N time durations from a start time of the second pulse signal PM2 and output an M-th third pulse signal PM3_M in the N third pulse signals at an end time of the M-th time duration, where one time duration in the N time durations corresponds to one third pulse signal in the N third pulse signals, and M is an integer greater than or equal to 1 and less than or equal to N.

Still taking FIG. 2 as an example for description, when M=1, the first time duration is time duration TC_1; when M=2, the second time duration is time duration TC_2; and when M=N, the N-th time duration is time duration TC_N. The time duration TC_1, the time duration TC_2, . . . , and the time duration TC_N are all greater than or equal to 0, and can be the same or different between any two time durations. The first third pulse signal PM3_1 is output at an end moment of the first time duration TC_1 by delaying the start moment (i.e., moment T2) of the second pulse signal PM2 by the first time duration TC_1; the second third pulse signal PM3_2 is output at an end moment of the second time duration TC_2 by delaying the start moment of the second pulse signal PM2 by the second time duration TC_2; and the N-th third pulse signal PM3_N is output at an end moment of the N-th time duration TC_N by delaying the start moment of the N-th pulse signal PMN by the N-th time duration TC_N. As can be seen, the start moment of each third pulse signal can be determined by the moment at which the start moment of the second pulse signal PM2 passes through a fixed time duration, that is, each third pulse signal can be determined by the second pulse signal PM2. After each third pulse signal is input to the transmitting module 30, the transmitting module 30 will emit laser light, that is, the moment at which the transmitting module 30 emits laser light is determined by each third pulse signal. Thus, the moment at which the transmitting module 30 emits laser light can be determined by the second pulse signal PM2.

In conclusion, the receiving start moment of the receiving module 20 and the moment at which the transmitting module 30 emits laser light can both be determined by the second pulse signal PM2, so that the time difference between the receiving start moment of the receiving module 20 and the moment at which the transmitting module 30 emits laser light can be a fixed value, thereby synchronizing the receiving start moment of the receiving module 20 and the moment at which the transmitting module 30 emits laser light, and facilitating improvement of the accuracy of obtained detection information.

It can be understood that, in the embodiments of the present application, the receiving start moment of the receiving module 20 and the moment at which the transmitting module 30 emits laser light are synchronized, that is, the time difference between the receiving start moment of the receiving module 20 and the moment at which the transmitting module 30 emits laser light is a fixed value, and the fixed value can be any value and can be set based on an actual application scenario.

In some embodiments, as shown in FIG. 3, the transmitting module 30 is further configured to output N feedback signals to the control module 10 in response to the N third pulse signals, where each time laser light is emitted in response to a K-th third pulse signal in the N third pulse signals, a K-th feedback signal in the N feedback signals is output to the control module 10 based on the moment at which the laser light is emitted, and K is an integer greater than or equal to 1 and less than or equal to N. The control module 10 is further configured to determine the moment at which the transmitting module 30 emits laser light based on the K-th feedback signal, and adjust the detection information based on a difference between the moment at which the transmitting module 30 emits laser light and the start moment of the K-th third pulse signal.

The detection information is information corresponding to the target object determined by the control module 10 based on the echo signal, such as target distance, position, height, speed, attitude, and the like. Taking the target distance as an example, the time of flight can be obtained by the time of laser emission and the time of echo signal reception, so as to obtain the distance from the target object to the position of the transmitting module 30.

Specifically, in actual applications, due to temperature changes and the like, additional delays may occur in the signal transmission process, and thus the moment when the transmitting module 30 receives the third pulse signal deviates from the moment when the laser is actually emitted. Taking FIG. 2 as an example, from the moment T2, after the first duration TC_1, the first third pulse signal PM3_1 is input to the transmitting module 30, and the transmitting module 30 is expected to emit the laser at the end of the first duration TC_1. However, in actual applications, due to temperature changes and similar factors, additional delays in the signal transmission process may cause the moment of the laser's actual emission to occur later than the end of the first duration TC_1.

Based on this, the embodiment of the present application outputs the corresponding feedback signal to the control module 10 based on the time of each laser emission. Specifically, when K=1, the transmitting module 30 emits laser in response to the first third pulse signal PM3_1, and outputs the first feedback signal to the control module 10 based on the time of emitting laser; when K=2, the transmitting module 30 emits laser in response to the second third pulse signal PM3_2, and outputs the second feedback signal to the control module 10 based on the time of emitting laser; . . . ; when K=N, the transmitting module 30 emits laser in response to the N-th third pulse signal PM3_N, and outputs the N-th feedback signal to the control module 10 based on the time of emitting laser. Then the control module 10 can receive N feedback signals, and based on each feedback signal, the time of corresponding laser emission can be determined, that is, the control module 10 can determine the time of laser emission of the transmitting module 30 in response to the first third pulse signal PM3_1 based on the first feedback signal; the control module 10 can determine the time of laser emission of the transmitting module 30 in response to the second third pulse signal PM3_2 based on the second feedback signal; . . . ; the control module 10 can determine the time of laser emission of the transmitting module 30 in response to the N-th third pulse signal PM3_N based on the N-th feedback signal. Then, when determining the detection information, the control module 10 can adjust the detection information according to the difference between the time of laser emission of the transmitting module 30 and the start time of the corresponding third pulse signal. Specifically, after the transmitting module 30 emits laser in response to the first third pulse signal PM3_1, the control module 10 adjusts the detection information corresponding to the target object determined based on the echo signal based on the difference between the time of laser emission and the start time of the first third pulse signal PM3_1; after the transmitting module 30 emits laser in response to the second third pulse signal PM3_2, the control module 10 adjusts the detection information corresponding to the target object determined based on the echo signal based on the difference between the time of laser emission and the start time of the second third pulse signal PM3_2; . . . ; after the transmitting module 30 emits laser in response to the N-th third pulse signal PM3_N, the control module 10 adjusts the detection information corresponding to the target object determined based on the echo signal based on the difference between the time of laser emission and the start time of the N-th third pulse signal PM3_N. Taking the detection information as the target distance as an example, the flight time obtained by the emission time of laser and the receiving time of the echo signal can be prolonged due to additional delays, causing the calculated target distance is longer than the actual distance. In this case, after the target distance is determined according to the flight time, the target distance can be reduced according to the difference between the obtained time of laser emission and the start time of the corresponding third pulse signal. For example, the greater the difference, the greater the reduction; conversely, the smaller the difference, the smaller the reduction.

Thus, the detection information is adjusted based on the actual laser emission conditions, which helps mitigate or eliminate the adverse effects caused by the additional delays due to temperature changes, thereby improving the accuracy of the obtained detection information.

In some embodiments, the control module 10 is further configured to obtain an M-th third pulse signal based on the second pulse signal, where a pulse width of the M-th third pulse signal is smaller than a pulse width of the second pulse signal. That is, the pulse width of each of the first third pulse signal PM3_1, the second third pulse signal PM3_2, . . . , and the N-th third pulse signal PM3_N can be determined by the second pulse signal, so that the pulse width of each third pulse signal can be configured according to requirements. For example, in some implementations, the pulse width of each third pulse signal can be configured to be in the order of nanoseconds, for example, in the range of several nanoseconds to tens of nanoseconds, so that the time resolution of the laser transceiver circuit 100 can be significantly improved to improve the accuracy of the obtained detection information, and the energy emitted each time the laser is emitted can be reduced to reduce energy consumption.

In some embodiments, the control module 10 includes a delay array and a logic operation array. The delay array includes at least one delay unit, and each delay unit provides a time length for delay. The delay array can provide T time lengths, where a J-th time length of the T time lengths can be provided by one or more delay units, and when the J-th time length of the T time lengths is provided by a plurality of delay units, the J-th time length is a sum of time lengths provided by the plurality of delay units, T is an integer greater than or equal to 1, and J is an integer greater than or equal to 1 and less than or equal to T. It can be understood that the time length provided by each delay unit can be the same or different. The logic operation array includes at least one logic operation unit, and each logic operation unit is configured to implement a logic operation, such as an AND logic operation or an NOT logic operation, and the logic operations implemented by different logic operation units can be the same or different. Then, after the second pulse signal is input to the control module 10, the combination of the delay array and the logic operation array can obtain the N third pulse signals by delaying and adjusting the pulse width based on the second pulse signal PM2.

It can be understood that there can be multiple different implementations for obtaining any third pulse signal (i.e., the M-th third pulse signal PM3_M) of the N third pulse signals based on the second pulse signal PM2 by the combination of the delay array and the logic operation array, and the results of different implementations can be the same or different, for example, the pulse width of the M-th third pulse signal PM3_M obtained by different implementations can be the same or different. Four exemplary implementations are described below.

Referring to FIG. 4 and FIG. 5, FIG. 4 is a first schematic diagram (i.e., a first implementation) of a composition block diagram of the control module 10 provided by the embodiment of the present application, and FIG. 5 is a schematic diagram of each signal in the control module 10 shown in FIG. 4.

The input end of the first delay unit 11 and the first input end of the first AND unit 13 are both input with the second pulse signal PM2, the output end of the first delay unit 11 is connected with the input end of the first inversion unit 12, the output end of the first inversion unit 12 is connected with the second input end of the first AND unit 13, the output end of the first AND unit 13 outputs an M-th third pulse signal PM3_M, and the M-th third pulse signal PM3_M is any one of a first third pulse signal PM3_1, a second third pulse signal PM3_2, . . . , and an N-th third pulse signal PM3_N.

Specifically, the delay duration of the first delay unit 11 is the duration TD. After the second pulse signal PM2 is delayed by the first delay unit 11, a pulse signal PM2_1 is output. The first inversion unit 12 performs a NOT logic operation on the pulse signal PM2_1 to obtain a pulse signal PM2_2. The second pulse signal PM2 and the pulse signal PM2_2 are both input to the first AND unit 13 to perform an AND logic operation to obtain the M-th third pulse signal PM3_M. The pulse width of the M-th third pulse signal PM3_M is the duration TD. The starting moment of the M-th third pulse signal PM3_M is the starting moment of the second pulse signal PM2.

Referring to FIG. 6 and FIG. 7, FIG. 6 is a second schematic diagram (i.e., a second implementation) of a composition block diagram of the control module 10 provided by the embodiment of the present application, and FIG. 7 is a schematic diagram of each signal in the control module 10 shown in FIG. 6.

As shown in FIG. 6 and FIG. 7, the control module 10 includes a second delay unit 14, a second inversion unit 15, and a second AND unit 16. That is, the delay array includes one delay unit, i.e., the second delay unit 14, and provides one delay duration (duration TE1); and the logic operation array includes two logic operation units, i.e., the second inversion unit 15 and the second AND unit 16.

The input end of the second delay unit 14 and the input end of the second inversion unit 15 are both input with the second pulse signal PM2, the output end of the second inversion unit 15 is connected with the first input end of the second AND unit 16, the output end of the second delay unit 14 is connected with the second input end of the second AND unit 16, and the output end of the second AND unit 16 outputs the M-th third pulse signal PM3_M.

Specifically, the second delay unit 14 has a delay time TE1. The second pulse signal PM2 is delayed by the second delay unit 14 and output as a pulse signal PM2_3. The second pulse signal PM2 is input to the second inversion unit 15 and inverted to obtain a pulse signal PM2_4. The pulse signal PM2_3 and the pulse signal PM2_4 are input to the second AND unit 16 to perform an AND operation and obtain an M-th third pulse signal PM3_M. The M-th third pulse signal PM3_M has a pulse width TE3, and the pulse width of the second pulse signal PM2 is TE1+TE2=TE2+TE3, so TE3=TE1, and the pulse signal PM3_M has the pulse width TE1. The M-th third pulse signal PM3_M starts at a time when the start time of the second pulse signal PM2 is delayed by the pulse width of the second pulse signal PM2, that is, the start time of the M-th third pulse signal PM3_M is a time when the start time of the second pulse signal PM2 is delayed by the time TE1 and the time TE2.

Referring to FIG. 8 and FIG. 9, FIG. 8 is a third schematic diagram (i.e., a third implementation) of a block diagram of the control module 10, and FIG. 9 is a schematic diagram of signals in the control module 10.

As shown in FIG. 8 and FIG. 9, the control module 10 includes a third delay unit 17, a fourth delay unit 18, a third inversion unit 19, and a third AND unit 11a. That is, the delay array includes two delay units, i.e., the third delay unit 17 and the fourth delay unit 18, and provides two delay times (i.e., time TF1 and time TF2); and the logic operation array includes two logic operation units, i.e., the third inversion unit 19 and the third AND unit 11a.

The input end of the third delay unit 17 is input with the second pulse signal PM2, the output end of the third delay unit 17 is connected with the first input end of the third AND unit 11a and the input end of the fourth delay unit 18 respectively, the output end of the fourth delay unit 18 is connected with the input end of the third inversion unit 19, the output end of the third inversion unit 19 is connected with the second input end of the third AND unit 11a, and the output end of the third AND unit 11a outputs the M-th third pulse signal PM3_M.

Specifically, the third delay unit 17 has a delay time of the time length TF1. The second pulse signal PM2 is delayed by the third delay unit 17 and output as a pulse signal PM2_5. The fourth delay unit 18 has a delay time of the time length TF2. The pulse signal PM2_5 is delayed by the fourth delay unit 18 and output as a pulse signal PM2_6. The pulse signal PM2_6 is input to the third inversion unit 19 and inverted to obtain a pulse signal PM2_7. The pulse signal PM2_5 and the pulse signal PM2_7 are input to the third AND unit 11a to perform an AND operation and obtain an M-th third pulse signal PM3_M. The M-th third pulse signal PM3_M has a pulse width of the time length TF2. The M-th third pulse signal PM3_M starts at a time point that is the time point of the start of the second pulse signal PM2 delayed by the time length TF1.

Referring to FIG. 10 and FIG. 11, FIG. 10 is a fourth schematic diagram (i.e., a fourth implementation manner) of a composition block diagram of the control module 10 provided by an embodiment of the present application, and FIG. 11 is a schematic diagram of signals in the control module 10 shown in FIG. 10.

As shown in FIG. 10 and FIG. 11, the control module 10 includes a fifth delay unit 12a, a sixth delay unit 13a, a fourth AND unit 14a, and a fourth inversion unit 15a. That is, the delay array includes two delay units, i.e., the fifth delay unit 12a and the sixth delay unit 13a, and provides two delay time lengths (i.e., the time length TG1 and the time length TG2); and the logic operation array includes two logic operation units, i.e., the fourth inversion unit 15a and the fourth AND unit 14a.

The input end of the fifth delay unit 12a is input with the second pulse signal PM2, the output end of the fifth delay unit 12a is connected with the input end of the fourth inversion unit 15a and the input end of the sixth delay unit 13a respectively, the output end of the fourth inversion unit 15a is connected with the first input end of the fourth AND unit 14a, the output end of the sixth delay unit 13a is connected with the second input end of the fourth AND unit 14a, and the output end of the fourth AND unit 14a outputs the M-th third pulse signal PM3_M.

Specifically, the fifth delay unit 12a has a delay time of the time length TG1. The second pulse signal PM2 is output as a pulse signal PM2_8 after passing through the fifth delay unit 12a. The sixth delay unit 13a has a delay time of the time length TG2. The pulse signal PM2_8 is output as a pulse signal PM2_9 after passing through the sixth delay unit 13a. The pulse signal PM2_8 is input to the fourth inversion unit 15a and is output as a pulse signal PM2_10 after performing a NOT logical operation. The pulse signal PM2_9 and the pulse signal PM2_10 are both input to the fourth AND unit 14a to perform an AND logical operation and obtain an M-th third pulse signal PM3_M. The pulse signal PM3_M has a pulse width of the time length TG2. The M-th third pulse signal PM3_M starts at a time point that is the time point of the start of the second pulse signal PM2 plus the time length TG1 and a pulse width of one second pulse signal PM2, that is, the time point that is the time point of the start of the second pulse signal PM2 plus the time length TG1 and the time length TG3.

It should be noted that the above embodiments only exemplarily show four ways of obtaining the M-th third pulse signal PM3_M based on the second pulse signal PM2. In other embodiments, other ways can be set to obtain the M-th third pulse signal PM3_M based on the second pulse signal PM2. In addition, the pulse widths of different third pulse signals in one third pulse signal PM3_1, a second third pulse signal PM3_2, . . . , and an N-th third pulse signal PM3_N can be the same or different, and different third pulse signals can be obtained by the same way or different ways. For example, in some embodiments, N=2, the first third pulse signal PM3_1 is obtained by the way shown in FIG. 4, and the second third pulse signal PM3_2 is obtained by the way shown in FIG. 6.

An embodiment of the present application further provides a laser detection device. The laser detection device includes the housing and the laser transceiver circuit 100.

In some embodiments, the laser detection device can be a laser radar, a signal processing device in the laser radar, or any device having a ranging and speed measurement function, for example, a ranging and speed measurement sensor or a ranging and speed measurement instrument.

In some embodiments, when the laser detection device is a laser radar, the laser radar can be applied to any device that performs laser detection, for example, a vehicle. The laser radar can detect the distance and speed parameters between the vehicle and obstacles, and the vehicle uses the laser radar system to detect nearby obstacles, such as other vehicles, stationary roadside objects, or rapidly approaching flying objects, thereby enabling the vehicle to plan a path based on the detected information and avoid collisions.

The above description merely illustrates certain embodiments of the present application and is not intended to limit the scope of the present application. Any equivalent structure or equivalent process transformation, or direct or indirect application in other related technical fields derived from the content of the specification and drawings of the present application are also included within the protection scope of the present application.

The above embodiments are only used for describing the technical solutions of the present application and are not used for limiting the present application. Under the spirit of the present application, the technical features in the above embodiments or in different embodiments can be combined, and the steps can be implemented in any order. Those skilled in the art should understand that the technical solutions disclosed in the foregoing embodiments may be modified, or part of the technical features may be equivalently replaced. These modifications or replacements do not cause the essence of the corresponding technical solutions deviate from the scope of the technical solutions of the embodiments of the present application.

What is claimed is:

1. A laser transceiver circuit, comprising:
a control module, configured to output a first pulse signal;
a receiving module, connected with the control module, configured to receive the first pulse signal, and output a second pulse signal based on the first pulse signal, and determine a receiving start time of the receiving module based on the second pulse signal, wherein the receiving module starts to receive an echo signal reflected by a target object from the receiving start time;
the control module is further configured to receive the second pulse signal, and output N third pulse signals based on the second pulse signal, wherein N is an integer greater than or equal to 1; and
a transmitting module, connected with the control module, configured to receive the N third pulse signals, and transmit laser to the target object based on the N third pulse signals.

2. The laser transceiver circuit of claim 1, wherein the receiving module is further configured to determine the receiving start time of the receiving module based on a time point at which a first preset time duration elapses from a start time point of the second pulse signal.

3. The laser transceiver circuit of claim 1, wherein the control module is further configured to delay for an M-th time duration of N time durations from a start time point of the second pulse signal, and output an M-th third pulse signal of the N third pulse signals at a time point at which the M-th time duration ends, wherein one time duration of the N time durations corresponds to one third pulse signal of the N third pulse signals, and M is an integer greater than or equal to 1 and less than or equal to N.

4. The laser transceiver circuit of claim 3, wherein the control module is further configured to obtain the M-th third pulse signal based on the second pulse signal, wherein a pulse width of the M-th third pulse signal is less than a pulse width of the second pulse signal.

5. The laser transceiver circuit of claim 4, wherein the control module comprises a first delay unit, a first inverse unit, and a first phase and unit; and
an input of the first delay unit and a first input of the first AND unit are both input with the second pulse signal, an output of the first delay unit is connected with an input of the first inverse unit, an output of the first inverse unit is connected with a second input of the first AND unit, and an output of the first AND unit outputs the M-th third pulse signal.

6. The laser transceiver circuit of claim 4, wherein the control module comprises a second delay unit, a second inverse unit, and a second AND unit,
wherein an input end of the second delay unit and an input end of the second inverse unit are both input with the second pulse signal, an output end of the second inverse unit is connected with a first input end of the second AND unit, an output end of the second delay unit is connected with a second input end of the second AND unit, and an output end of the second AND unit outputs the M-th third pulse signal.

7. The laser transceiver circuit according to claim 4, wherein the control module comprises a third delay unit, a fourth delay unit, a third inverse unit, and a third AND unit,
wherein an input end of the third delay unit is input with the second pulse signal, an output end of the third delay unit is connected with a first input end of the third AND unit and an input end of the fourth delay unit respectively, an output end of the fourth delay unit is connected with an input end of the third inverse unit, an output end of the third inverse unit is connected with a second input end of the third AND unit, and an output end of the third AND unit outputs the M-th third pulse signal.

8. The laser transceiver circuit according to claim 4, wherein the control module comprises a fifth delay unit, a sixth delay unit, a fourth inverse unit, and a fourth AND unit,
wherein an input end of the fifth delay unit is input with the second pulse signal, an output end of the fifth delay unit is connected with an input end of the fourth inverse unit and an input end of the sixth delay unit respectively, an output end of the fourth inverse unit is connected with a first input end of the fourth AND unit, an output end of the sixth delay unit is connected with a second input end of the fourth AND unit, and an output end of the fourth AND unit outputs the M-th third pulse signal.

9. The laser transceiver circuit according to claim 1, wherein the transmitting module is further configured to output N feedback signals to the control module in response to the N third pulse signals, wherein a K-th feedback signal of the N feedback signals is output to the control module based on a time of transmitting laser light each time laser light is transmitted in response to a K-th third pulse signal of the N third pulse signals, K being an integer greater than or equal to 1 and less than or equal to N; and
the control module is further configured to determine a time of transmitting laser light by the transmitting module based on the K-th feedback signal, and adjust detection information based on a difference between the time of transmitting laser light by the transmitting module and a start time of the K-th third pulse signal, wherein the detection information is information corresponding to the target object determined by the control module based on the echo signal.

10. A laser detection device, comprising a laser transceiver circuit and a housing configured to mount the laser transceiver circuit, wherein the laser transceiver circuit comprises:
a control module, configured to output a first pulse signal;
a receiving module, connected with the control module, configured to receive the first pulse signal, and output a second pulse signal based on the first pulse signal, and determine a receiving start time of the receiving module based on the second pulse signal, wherein the receiving module starts to receive an echo signal reflected by a target object from the receiving start time;
the control module is further configured to receive the second pulse signal, and output N third pulse signals based on the second pulse signal, wherein N is an integer greater than or equal to 1; and
a transmitting module, connected with the control module, configured to receive the N third pulse signals, and transmit laser to the target object based on the N third pulse signals.
